(19) United States
(12) Patent Application Publication
(10) Pub. No.: US 2018/0115211 A1
(43) Pub. Date: Apr. 26, 2018

(54) ROTARY ELECTRIC MACHINE

(71) Applicant: MITSUBISHI ELECTRIC CORPORATION, Tokyo (JP)

(72) Inventors: Masashi NAKAMURA, Tokyo (JP); Ryuichi KITORA, Tokyo (JP); Akihiro YAMAMURA, Tokyo (JP); Koichi OJIMA, Tokyo (JP); Masaya INOUE, Tokyo (JP)

(73) Assignee: Mitsubishi Electric Corporation, Tokyo (JP)

(21) Appl. No.: 15/560,524

(22) PCT Filed: Mar. 31, 2015
(86) PCT No.: PCT/JP2015/060130

§ 371 Date: Sep. 22, 2017

(51) Int. Cl. H02K 3/52; H02K 3/18

(52) U.S. Cl. CPC H02K 3/522; H02K 3/18

(57) ABSTRACT

The rotary electric machine according to the present invention includes: a ring-shaped electrically insulating holder in which a plurality of groove portions are formed concentrically; a plurality of strip-shaped electrically conductive members that are formed so as to have strip-shaped bodies that have a rectangular cross section, and that are housed in each of the groove portions; and connecting conductors that each include: a circumferentially extending portion that extends circumferentially at the first axial end of the electrically insulating holder so as to be parallel to the strip-shaped electrically conductive member; and a radially extending portion that extends in a radial direction from an end portion at an opposite end of the circumferentially extending portion from the strip-shaped electrically conductive member by means of a bent portion, the radially extending portion at an opposite end from the bent portion being connected to the coil terminal.

### TECHNICAL FIELD

The present invention relates to a rotary electric machine such as an electric motor or a generator, and particularly relates to a connecting member for delivering electric power to and from a stator winding.

### BACKGROUND ART

Generally, temperature of a rotary electric machine rises when the rotary electric machine is driven, and the temperature of the rotary electric machine decreases when the driving of the rotary electric machine stops. Consequently, in conventional rotary electric machines, because connecting wiring and end portions of coils expand and contract due to temperatures of the connecting wiring and the coils changing, stresses due to expansion and contraction of the connecting wiring and the end portions of the coils act on connecting portions between the connecting wiring and the end portions of the coils, and there has been a possibility that deterioration in connection state and reductions in joining strength may occur.

In recent years, increased torque is desired in rotary electric machines, and increases in electric current carrying capacity for electric currents that are made to flow to stator windings and increases in stator size are being attempted. In order to enable increases in electric current carrying capacity for the electric currents that are made to flow to the stator winding, it is necessary to use conductor wires that have large cross-sectional areas in the connecting wiring, increasing the size and weight of the connecting wiring. Because displacement due to vibrational forces during vibration of the connecting wiring and due to thermal stresses are thereby increased, stresses that act on the connecting portions between the connecting wiring and the end portions of the coils are increased, and there has been a possibility that the state of the connections may deteriorate and joining strength may decrease.

Furthermore, electric motors and generators that are mounted to hybrid electric vehicles are required to operate in a wide temperature range from around 150 degrees Celsius to around −40 degrees Celsius. Because displacement due to temperature fluctuations is increased further if a large stator is used in such temperature environments, stresses that act on the connecting portions between the connecting wiring and the end portions of the coils are increased, and there has been a possibility that the state of the connections may deteriorate and joining strength may decrease, and in the worst cases wire breakage may even occur.

In consideration of such conditions, it has been proposed that wiring stress-alleviating portions be disposed in a vicinity of portions of connecting wiring that are connected to end portions of coils, to absorb displacement of the connecting wiring and the end portions of the coils that results from temperature fluctuations and application of vibrational forces by deformation of the wiring stress-alleviating portion and suppress deterioration in connection state and reductions in joining strength between the connecting wiring and the end portions of the coils (see Patent Literature 1, for example).

### CITATION LIST

### Patent Literature

Patent Literature 1: Japanese Patent No. 5245782 (Gazette)

### SUMMARY OF THE INVENTION

### Problem to be Solved by the Invention

However, in the conventional rotary electric machine that is described in Patent Literature 1, the wiring stress-alleviating portions are formed by reducing thicknesses of connecting wiring in a vicinity of the connections with the end portions of the coils, or by making widths narrower. Thus, cross-sectional area of the wiring stress-alleviating portions that are configured in this manner is reduced, and one problem has been that adaptation to applications in which electric current carrying capacity is increased is not possible.

In the conventional rotary electric machine that is described in Patent Literature 1, the wiring stress-alleviating portions are formed by bending the connecting wiring in a vicinity of connection to the end portions of the coils so as to have a V shape. However, because rigidity is inevitably greater in connecting wiring that has increased cross-sectional area that accompanies increases in electric current carrying capacity, another problem has been that processing to bend the connecting wiring into a V shape is difficult. Another problem has been that work hardening of the material is acute in localized bend processing, reducing stress-alleviating effects.

In addition, in the conventional rotary electric machine that is described in Patent Literature 1, because the end portions of the coils are connected to the connecting wiring axially outside coil ends, another problem has been that axial dimensions cannot be reduced.

The present invention aims to solve the above problems and an object of the present invention is to provide a rotary electric machine that enables adaptation to applications for increasing electric current carrying capacity, that eliminates need for a localized bending process for a V shape, etc., that increases machinability, that enables reductions in stress-alleviating effects due to work hardening to be suppressed, that enables axial dimensions to be reduced in size by disposing connecting conductors on a radially outer side or a radially inner side of a coil group, and that can suppress deterioration in connection state and reductions in connection strength of connecting portions between the connecting conductors and coil terminals due to vibrational forces or thermal stresses by enabling stresses to be alleviated in a radial direction and in a circumferential direction without reducing cross-sectional area for passage of electric current.

### Means for Solving the Problem

A rotary electric machine according to the present invention includes: a rotor; a stator including: a stator core in which a plurality of teeth are respectively arranged circumferentially so as to protrude radially inward from an inner circumferential surface of an annular back yoke portion; and a plurality of coils that are mounted to the stator core, and that each have a pair of coil terminals that protrude outward from the stator core at a first axial end thereof, the stator being disposed so as to be coaxial to the rotor so as to surround the rotor; and a connecting member for delivering electric power to and from the plurality of coils. The connecting member includes: an electrically insulating holder that is formed so as to have a ring shape, that is disposed on a radially outer side of the plurality of coils at the first axial end of the stator, or that is disposed on a radially inner side of the plurality of coils at the first axial end of the stator, and in which a plurality of groove portions are formed concentrically so as to have openings at a first axial end; a plurality of strip-shaped electrically conductive members that respectively extend circumferentially so as to be housed in each of the plurality of groove portions; and a plurality of connecting conductors that are each formed so as to have a strip-shaped body that has a rectangular cross section, that extend outward from a side portion at a first axial end of each of the plurality of strip-shaped electrically conductive members, and that pass along the first axial end of the electrically insulating holder such that a longitudinal axis of the rectangular cross section is parallel to an axial direction, each of the connecting conductors being connected to a coil terminal that is intended for connection therewith among the coil terminals, and the plurality of connecting conductors each include: a circumferentially extending portion that extends circumferentially at the first axial end of the electrically insulating holder so as to be parallel to the strip-shaped electrically conductive member after extending outward from the side portion at the first axial end of the strip-shaped electrically conductive member; and a radially extending portion that extends in a radial direction from an end portion at an opposite end of the circumferentially extending portion from the strip-shaped electrically conductive member by means of a bent portion, an end portion of the radially extending portion at an opposite end from the bent portion being connected to the coil terminal that is intended for connection therewith.

### Effects of the Invention

According to the present invention, because the connecting member is formed so as to have a ring shape, and is disposed on a radially outer side of the plurality of coils at the first axial end of the stator, or on a radially inner side of the plurality of coils at the first axial end of the stator, axial dimensions of the rotary electric machine can be reduced in size.

Because the connecting conductors are configured by linking the circumferentially extending portions and the radially extending portions using the bent portions, and the longitudinal axes of the rectangular cross sections are parallel to the axial direction of the rotary electric machine, displacement due to vibrational forces or thermal stresses is absorbed by elastic deformation of the connecting conductors, enabling deterioration in connection state and reductions in connection strength of the connecting portions between the connecting conductors and the coil terminals to be suppressed. It is also not necessary to partially reduce the cross-sectional area for passage of electric current, enabling use in applications with increased electric current carrying capacity. In addition, it is not necessary to apply localized processing such as forming V shapes on the connecting conductors, increasing machinability, and also enabling reductions in stress-alleviating effects due to work hardening to be suppressed.

### BRIEF DESCRIPTION OF THE DRAWINGS

FIG. 1 is a half section that shows a rotary electric machine according to Embodiment 1 of the present invention;

FIG. 2 is an oblique projection that shows a stator in the rotary electric machine according to Embodiment 1 of the present invention;

FIG. 3 is an oblique projection that shows the stator on which a connecting member is disposed in the rotary electric machine according to Embodiment 1 of the present invention;

FIG. 4 is a cross section that shows the stator on which the connecting member is disposed in the rotary electric machine according to Embodiment 1 of the present invention;

FIG. 5 is a partial cross section that shows a vicinity of the connecting member of the stator on which the connecting member is disposed in the rotary electric machine according to Embodiment 1 of the present invention;

FIG. 6 is a partial oblique projection that shows the vicinity of the connecting member of the stator on which the connecting member is disposed in the rotary electric machine according to Embodiment 1 of the present invention;

FIG. 7 is a partial plan that explains a punched shape of a strip-shaped electrically conductive member and a connecting conductor in the rotary electric machine according to Embodiment 1 of the present invention;

FIG. 8 is a diagram that explains stress-alleviating action in the rotary electric machine according to Embodiment 1 of the present invention;

FIG. 9 is a diagram that explains the stress-alleviating action in the rotary electric machine according to Embodiment 1 of the present invention;

FIG. 10 is an oblique projection that shows a stator on which a connecting member is disposed in a rotary electric machine according to Embodiment 2 of the present invention;

FIG. 11 is a partial oblique projection that shows a vicinity of the connecting member of a stator on which the connecting member is disposed in the rotary electric machine according to Embodiment 2 of the present invention; and

FIG. 12 is a partial top plan that shows the vicinity of the connecting member of the stator on which the connecting member is disposed in the rotary electric machine according to Embodiment 2 of the present invention.

### DESCRIPTION OF EMBODIMENTS

### Embodiment 1

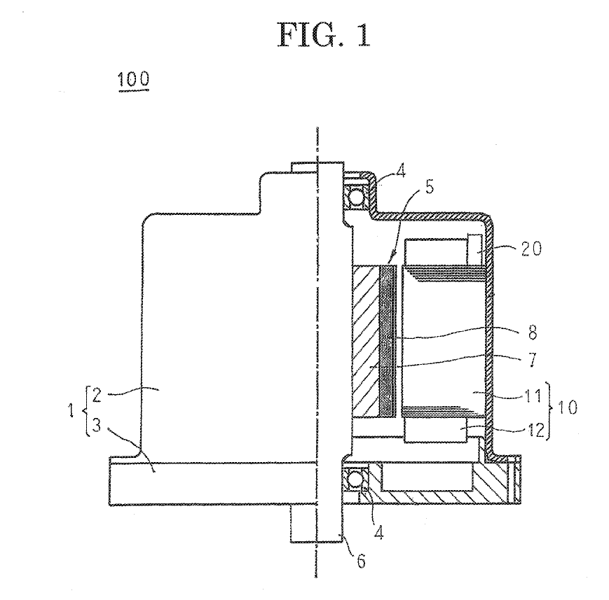

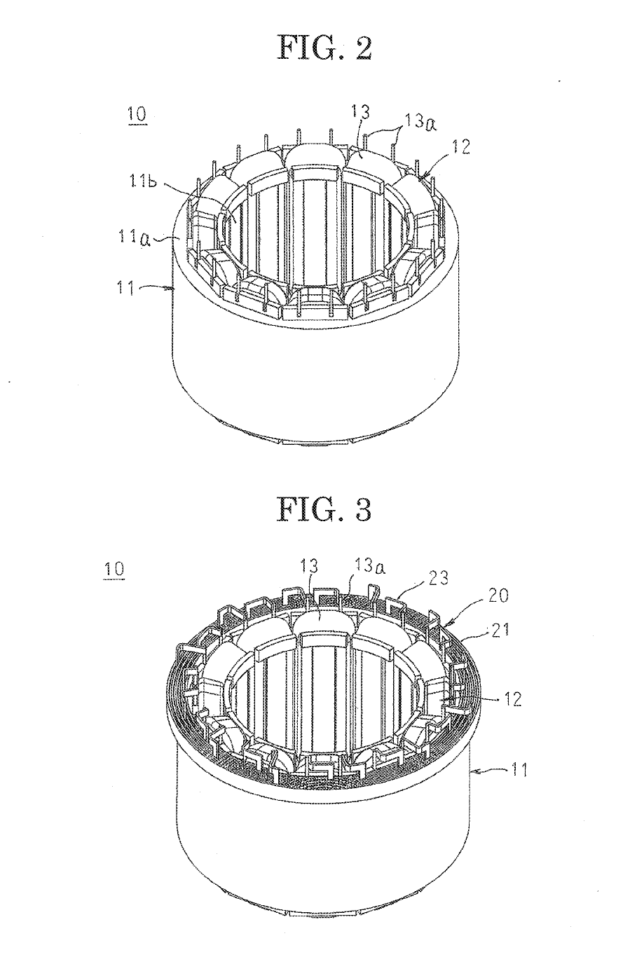

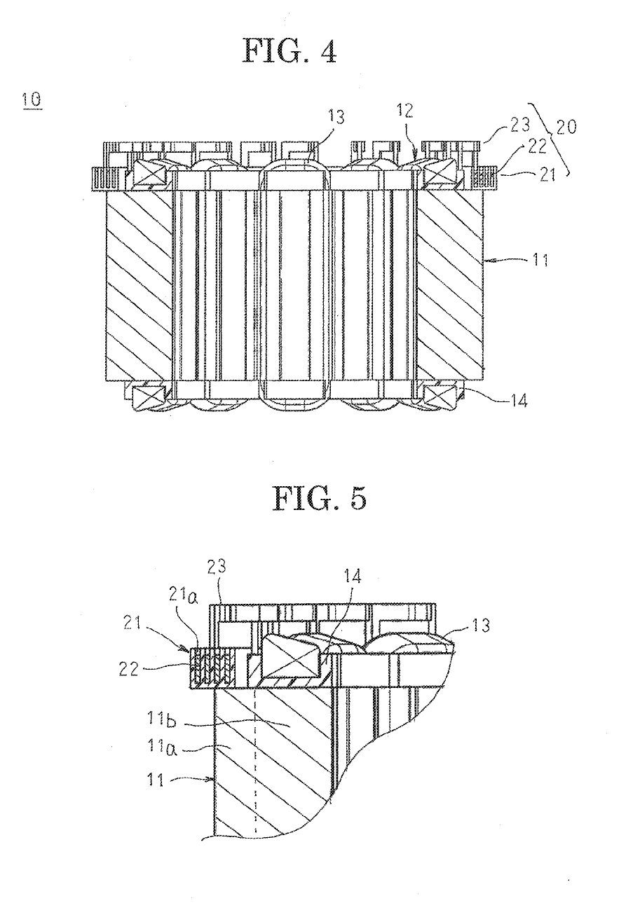

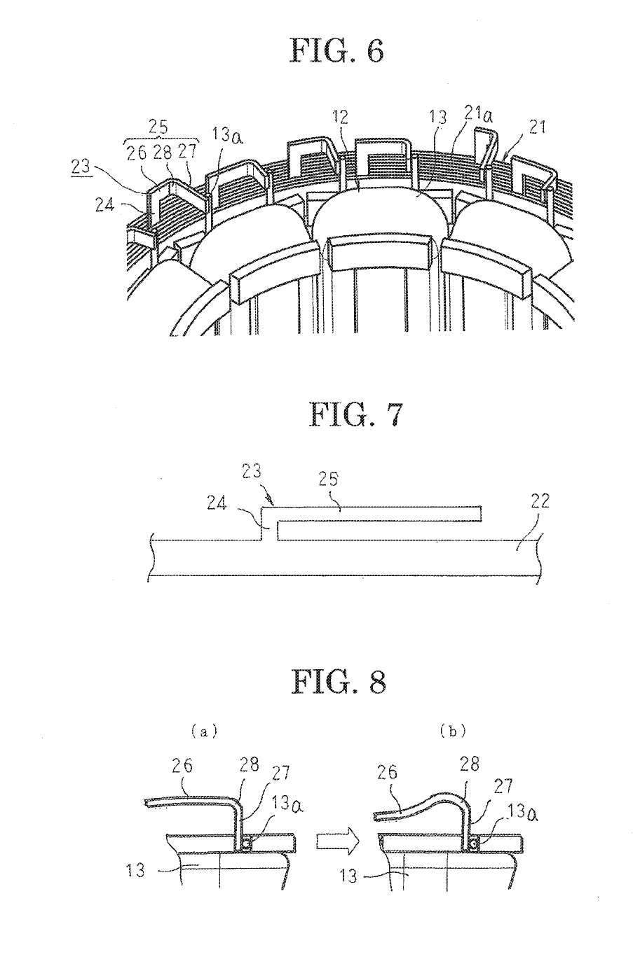

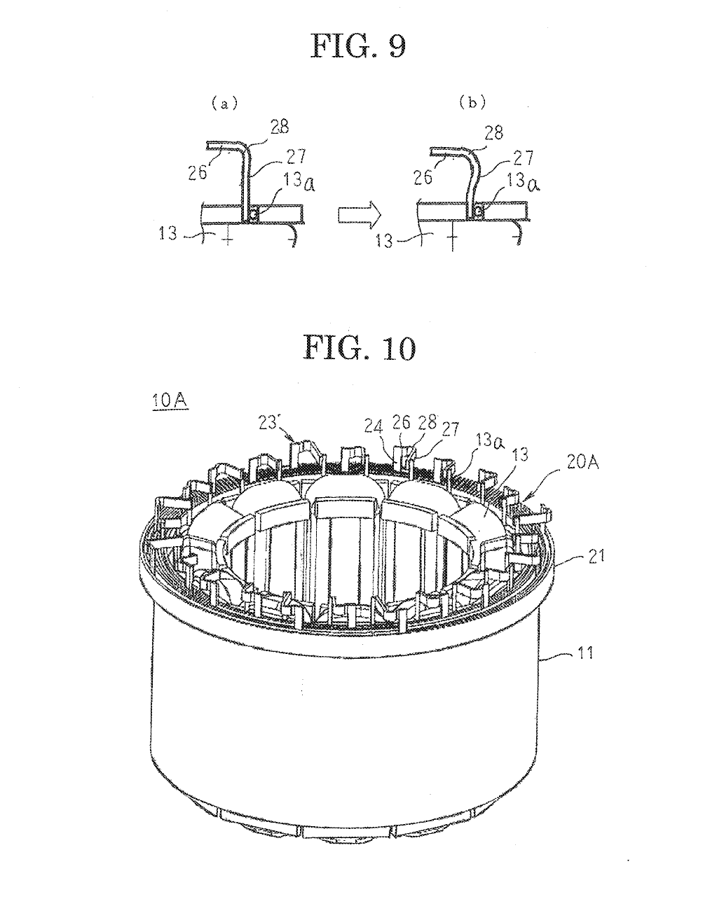

FIG. 1 is a half section that shows a rotary electric machine according to Embodiment 1 of the present invention, FIG. 2 is an oblique projection that shows a stator in the rotary electric machine according to Embodiment 1 of the present invention, FIG. 3 is an oblique projection that shows the stator on which a connecting member is disposed in the rotary electric machine according to Embodiment 1 of the present invention, FIG. 4 is a cross section that shows the stator on which the connecting member is disposed in the rotary electric machine according to Embodiment 1 of the present invention, FIG. 5 is a partial cross section that shows a vicinity of the connecting member of the stator on which the connecting member is disposed in the rotary electric machine according to Embodiment 1 of the present invention, FIG. 6 is a partial oblique projection that shows the vicinity of the connecting member of the stator on which the connecting member is disposed in the rotary electric machine according to Embodiment 1 of the present invention, and FIG. 7 is a partial plan that explains a punched shape of a strip-shaped electrically conductive member and a connecting conductor in the rotary electric machine according to Embodiment 1 of the present invention. FIGS. 8 and 9 are respective diagrams that explain stress-alleviating action in the rotary electric machine according to Embodiment 1 of the present invention.

In FIGS. 1 through 5, a rotary electric machine 100 includes: a housing 1 that has: a floored cylindrical frame 2; and an end plate 3 that closes an opening of the frame 2; a stator 10 that is inserted into and fixed to a cylindrical portion of the frame 2; a rotor 5 that is fixed to a rotating shaft 6 that is rotatably supported in the floor portion of the frame 2 and the end plate 3 by means of bearings 4 so as to be rotatably disposed on an inner circumferential side of the stator 10; and a connecting member 20 for delivering electric power to and from the stator 10.

The rotor 5 is a permanent-magnet rotor that includes: a rotor core 7 that is fixed to the rotating shaft 6, which is inserted so as to pass through a central position thereof; and permanent magnets 8 that are embedded in a vicinity of an outer circumferential surface of the rotor core 7 so as to be arranged at a uniform angular pitch circumferentially to constitute magnetic poles.

The stator 10 includes: a stator core 11; and a stator winding 12 that is mounted to the stator core 11. The stator core 11 includes: a back yoke portion 11a; and twelve teeth 11b that are arranged at a uniform angular pitch in a circumferential direction so as to each project radially inward from an inner circumferential surface of the back yoke portion. The stator winding 12 includes twelve coils 13 that are wound into concentrated windings on each of the teeth 11b. The coils 13 are produced by winding conductor wires around the teeth 11b and pairs of insulators 15 that are disposed on two ends of the teeth 11b. Pairs of coil terminals 13a that are two ends of the conductor wires protrude outward from radially outer sides of the coils 13 on opposite sides of the teeth 11b at a first axial end of the stator 10 so as to be parallel to an axial direction. In this case, twenty-four coil terminals 13a are arranged circumferentially so as to protrude outward from the radially outer sides of the coils 13 at the first axial end, as shown in FIG. 2.

Moreover, the pairs of coil terminals 13a protrudes outward from the radially outer sides of the coils 13 at the first axial end of the stator 10, but the pairs of coil terminals 13a may protrude outward from radially inner sides of the coils 13 at the first axial end of the stator 10, or first coil terminals 13a may protrude outward from the radially outer sides of the coils 13 at the first axial end of the stator 10, and second coil terminals 13a protrude outward from the radially inner sides of the coils 13 at the first axial end of the stator 10. Furthermore, a wire material that has good electrical conductivity such as a copper wire or an aluminium wire that is coated with insulation is used for the conductor wires.

The connecting member 20 is produced so as to have a ring shape using a resin material such as a nylon, and includes: a holder 21 in which four grooves 21a are formed in a concentric circular pattern; strip-shaped electrically conductive members 22 that are housed in each of the four grooves 21a, and that are disposed so as to extend in a circumferential direction; and connecting conductors 23 that extend outward from side portions of the strip-shaped electrically conductive members 22 on an open side of the grooves 21a outside the grooves 21a, that then extend in a circumferential direction outside the holder 21, and that are connected to coil terminals 13a that are intended for connection therewith.

The holder 21 is formed such that an inside diameter thereof is slightly larger than an inside diameter of the back yoke portion 11a, and is disposed above a first axial end surface of the back yoke portion 11a so as to avoid interference with the coils 13.

The connecting conductors 23 are formed by being punched out of a conductor sheet that has good electrical conductivity such as copper or aluminum by press molding, etc., so as to be integrated with the strip-shaped electrically conductive members 22, and are subsequently shaped by bending. As shown in FIG. 7, the connecting conductor 23 that is punched out of the conductor sheet so as to be integrated with the strip-shaped electrically conductive member 22 includes: a linking portion 24 that protrudes outward from a side portion of the strip-shaped electrically conductive member 22 on a first side in the width direction; and a main body portion 25 that extends in the longitudinal direction of the strip-shaped electrically conductive member 22 from a protruding end of the linking portion 24 so as to be parallel to the strip-shaped electrically conductive member 22. A circumferentially extending portion 26 and a radially extending portion 27 are formed by bending the main body portion 25 approximately perpendicularly partway along the longitudinal direction of the main body portion 25 using a flat surface that is constituted by a long side of a rectangular cross section as a radially inner surface. A linking portion between the circumferentially extending portion 26 and the radially extending portion 27 forms a bent portion 28.

As shown in FIGS. 3 through 5, the connecting member 20 that is configured in this manner is disposed above the first axial end surface of the back yoke portion 11a of the stator core 11 such that the openings of the grooves 21a are oriented in a first axial direction of the stator 10, and tip portions of the connecting conductors 23 are connected to the coil terminals 13a that are intended for connection therewith by TIG welding, etc. Thus, the connecting conductors 23 protrude outward from the grooves 21a of the holder 21 in the first axial direction, extend circumferentially so as to be parallel to the strip-shaped electrically conductive members 22 axially outside the holder 21, are bent approximately perpendicularly at the bent portions 28 and extend radially inward, and are connected to the coil terminals 13a that are intended for connection therewith. The portions that extend circumferentially so as to be parallel to the strip-shaped electrically conductive members 22 axially outside the holder 21 are the circumferentially extending portions 26, and the regions that extend radially inward from the bent portions 28 are the radially extending portions 27. Here, the connecting conductors 23 extend circumferentially and radially such that the longitudinal axes of the rectangular cross sections are parallel to the axial direction axially outside the holder 21.

Here, twelve coils 13 are arranged in order of a U phase, a V phase, and a W phase repeatedly in the circumferential direction, the strip-shaped electrically conductive member 22 that is housed in the innermost groove 21a is a strip-shaped electrically conductive member for neutral-point connection, and the strip-shaped electrically conductive members 22 that are housed in the remaining three grooves 21a are strip-shaped electrically conductive members for the U phase, the V phase, and the W phase, respectively. In this case, twelve connecting conductors 23 are formed integrally on the strip-shaped electrically conductive member 22 for neutral-point connection, and four connecting conductors 23 are formed integrally on each of the strip-shaped electrically conductive members 22 for the U phase, the V phase, and the W phase. The first coil terminals 13a of the respective coils 13 are connected to the strip-shaped electrically conductive member 22 for neutral-point connection by means of the connecting conductors 23. Second coil terminals 13a of four coils 13 are connected to each of the strip-shaped electrically conductive members 22 for the U phase, the V phase, and the W phase by means of the connecting conductors 23. The U-phase coil, the V-phase coil, and the W-phase coil, which are each formed by connecting four coils 13 in parallel, are thereby wye-connected to form the stator winding 12.

In the rotary electric machine 100 that is configured in this manner, the connecting conductors 23 include: circumferentially extending portions 26 that protrude axially outward from the grooves 21a of the holder 21 such that the longitudinal axes of the rectangular cross sections are parallel to the axial direction, and that extend circumferentially so as to be parallel to the strip-shaped electrically conductive members 22 axially outside the holder 21; and radially extending portions 27 that are bent approximately perpendicularly at the bent portions 28 and extend radially inward, and that are connected to the coil terminals 13a that are intended for connection therewith.

Stress-absorbing action by the connecting conductors 23 will now be explained with reference to FIGS. 8 and 9.

FIG. 8 shows a case in which a length of the radially extending portion 27 is shorter than a length of the circumferentially extending portion 26. In this case, rigidity in the direction of bending in which the flat surface that is constituted by a long side of the rectangular cross section of the radially extending portion 27 is a radially inner surface is greater than rigidity in the direction of bending in which the flat surface that is constituted by a long side of the rectangular cross section of the circumferentially extending portion 26 is a radially inner surface. In other words, the circumferentially extending portion 26 bends more easily than the radially extending portion 27.

Thus, if the linking portion 24 displaces radially inward relative to the coil terminal 13a from the state that is shown in FIG. 8(a) due to thermal stresses or vibrational forces, then the circumferentially extending portion 26 deforms elastically, and the elastic force thereof acts so as to pivot the bent portion 28 counterclockwise in FIG. 8(a) around a flexural center of the bent portion 28. Here, because the circumferentially extending portion 26 bends more easily than the radially extending portion 27, a vicinity of the bent portion 28 of the circumferentially extending portion 26 mainly curves convexly radially outward, as shown in FIG. 8(b). The stresses that act on the connecting portion between the connecting conductor 23 and the coil terminal 13a due to thermal stresses or vibrational forces are thereby absorbed.

If the linking portion 24 displaces radially outward relative to the coil terminal 13a from the state that is shown in FIG. 8(a) due to thermal stresses or vibrational forces, then the circumferentially extending portion 26 deforms elastically, and the elastic force thereof acts so as to pivot the bent portion 28 clockwise in FIG. 8(a) around the flexural center of the bent portion 28. Here, because the circumferentially extending portion 26 bends more easily than the radially extending portion 27, the circumferentially extending portion 26 mainly curves in a convex arc radially inward and the bent portion 28 displaces obliquely downward to the left. The stresses that act on the connecting portion between the connecting conductor 23 and the coil terminal 13a due to thermal stresses or vibrational forces are thereby absorbed.

If the linking portion 24 displaces to the right relative to the coil terminal 13a in FIG. 8(a) due to thermal stresses or vibrational forces, then the bent portion 28 is pressed to the right in FIG. 8(a). Here, because the circumferentially extending portion 26 bends more easily than the radially extending portion 27, a vicinity of the bent portion 28 of the circumferentially extending portion 26 curves convexly radially outward, and the amount of curvature of the radially extending portion 27 is insignificant. The stresses that act on the connecting portion between the connecting conductor 23 and the coil terminal 13a due to thermal stresses or vibrational forces are thereby absorbed.

If the linking portion 24 displaces to the left relative to the coil terminal 13a in FIG. 8(a) due to thermal stresses or vibrational forces, then the bent portion 28 is pulled to the left in FIG. 8(a). Thus, the bent portion 28 displaces obliquely downward to the left, and the bending angle of the bent portion 28 widens, curving the circumferentially extending portion 26 and the radially extending portion 27 slightly. The stresses that act on the connecting portion between the connecting conductor 23 and the coil terminal 13a due to thermal stresses or vibrational forces are thereby absorbed.

FIG. 9 shows a case in which a length of the radially extending portion 27 is longer than a length of the circumferentially extending portion 26. In this case, rigidity in the direction of bending in which the flat surface that is constituted by a long side of the rectangular cross section of the radially extending portion 27 is a radially inner surface is less than rigidity in the direction of bending in which the flat surface that is constituted by a long side of the rectangular cross section of the circumferentially extending portion 26 is a radially inner surface. In other words, the radially extending portion 27 bends more easily than the circumferentially extending portion 26.

Thus, if the linking portion 24 displaces radially inward relative to the coil terminal 13a from the state that is shown in FIG. 9(a) due to thermal stresses or vibrational forces, then the circumferentially extending portion 26 deforms elastically, and the elastic force thereof acts so as to pivot the bent portion 28 counterclockwise in FIG. 9(a) around a flexural center of the bent portion 28. Here, because the radially extending portion 27 bends more easily than the circumferentially extending portion 26, a vicinity of the bent portion 28 of the radially extending portion 27 mainly curves convexly in an opposite circumferential direction from the circumferentially extending portion 26, as shown in FIG. 9(b). The stresses that act on the connecting portion between the connecting conductor 23 and the coil terminal 13a due to thermal stresses or vibrational forces are thereby absorbed.

If the linking portion 24 displaces radially outward relative to the coil terminal 13a from the state that is shown in FIG. 9(a) due to thermal stresses or vibrational forces, then the circumferentially extending portion 26 deforms elastically, and the elastic force thereof acts so as to pivot the bent portion 28 clockwise in FIG. 9(a) around the flexural center of the bent portion 28. Here, because the radially extending portion 27 bends more easily than the circumferentially extending portion 26, the radially extending portion 27 mainly curves in a convex arc circumferentially toward the circumferentially extending portion 26 and the bent portion 28 displaces obliquely downward to the left. The stresses that act on the connecting portion between the connecting conductor 23 and the coil terminal 13a due to thermal stresses or vibrational forces are thereby absorbed.

If the linking portion 24 displaces to the right relative to the coil terminal 13a in FIG. 9(a) due to thermal stresses or vibrational forces, then the bent portion 28 is pressed to the right in FIG. 9(a). Here, because the radially extending portion 27 bends more easily than the circumferentially extending portion 26, a vicinity of the bent portion 28 of the radially extending portion 27 curves convexly in an opposite circumferential direction from the circumferentially extending portion 26. The stresses that act on the connecting portion between the connecting conductor 23 and the coil terminal 13a due to thermal stresses or vibrational forces are thereby absorbed.

If the linking portion 24 displaces to the left relative to the coil terminal 13a in FIG. 9(a) due to thermal stresses or vibrational forces, then the bent portion 28 is pulled to the left in FIG. 9(a). Thus, the bent portion 28 displaces obliquely downward to the left, and the bending angle of the bent portion 28 widens, curving the circumferentially extending portion 26 and the radially extending portion 27 slightly. The stresses that act on the connecting portion between the connecting conductor 23 and the coil terminal 13a due to thermal stresses or vibrational forces are thereby absorbed.

Thus, displacement of the connecting conductors 23 in the circumferential direction and the radial direction due to vibrational forces during vibration or thermal stresses is absorbed by the circumferentially extending portions 26 and the radially extending portions 27 deforming elastically. Because increases in stresses that act on the connecting portions between the radially extending portions 27 and the coil terminals 13a are suppressed thereby, the state of the connections between the radially extending portions 27 and the coil terminals 13a will not deteriorate, nor will connection strength decrease, improving connection reliability of the connecting portions between the radially extending portions 27 and the coil terminals 13a.

Because it is not necessary to reduce the thickness of the connecting conductors 23, or to make the width thereof narrower, as it was in Patent Literature 1, cross-sectional area of the connecting conductors 23 for passage of electric current can be ensured, enabling adaptation to increases in electric current carrying capacity.

Because the circumferentially extending portions 26 and the radially extending portions 27 can be formed simply by bending the main body portions 25 of the connecting conductors 23 approximately perpendicularly at the bent portions 28, it is not necessary to bend the connecting conductors 23 into a V shape as it was in Patent Literature 1, facilitating processing even if the cross-sectional area of the connecting conductors 23 is increased. Furthermore, because localized bend processing such as for the V shape is no longer required, reductions in stress-alleviating effects that result from work hardening can be suppressed.

Because the connecting conductors 23 are disposed axially outside the holder 21, increases in axial dimensions of the coil ends of the stator winding 12 are suppressed, enabling the rotary electric machine 100 to be reduced in size.

Now, a radial length of the radially extending portions 27 is longer in the connecting conductors 23 that are linked to the strip-shaped electrically conductive members 22 that are housed in the grooves 21a that are positioned on a radially outer side, making vibration resistance of the connecting conductors 23 deteriorate. Thus, by configuring the connecting conductors 23 such that a circumferential length of the circumferentially extending portions 26 becomes shorter if the radial length of the radially extending portions 27 becomes longer, deterioration of vibration resistance is suppressed, enabling both thermal stresses that act on the connecting portions between the connecting conductors 23 and the coil terminals 13a and stresses due to application of vibrational forces to be reduced.

Moreover, in Embodiment 1 above, the holder 21 is disposed at a first axial end of the stator core 11 radially outside a group of coils 13, but the holder 21 may be disposed at the first axial end of the stator core 11 radially inside the group of coils 13 so as to avoid interference with the rotor 5. In that case, the radially extending portions 27 are formed so as to extend radially outward from the bent portions 28.

### Embodiment 2

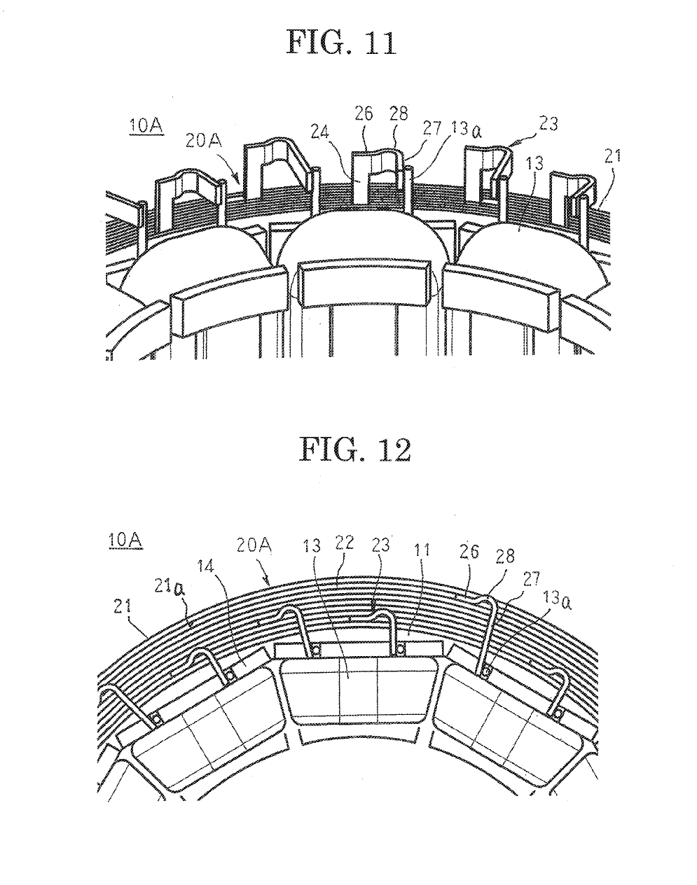

FIG. 10 is an oblique projection that shows a stator on which a connecting member is disposed in a rotary electric machine according to Embodiment 2 of the present invention, FIG. 11 is a partial oblique projection that shows a vicinity of the connecting member of a stator on which the connecting member is disposed in the rotary electric machine according to Embodiment 2 of the present invention, and FIG. 12 is a partial top plan that shows the vicinity of the connecting member of the stator on which the connecting member is disposed in the rotary electric machine according to Embodiment 2 of the present invention.

In FIGS. 10 through 12, a connecting member 20A includes: a holder 21; strip-shaped electrically conductive members 22; and connecting conductors 23′. The connecting conductors 23′ include: a circumferentially extending portion 26; a radially extending portion 27; and a bent portion 28′ that links the circumferentially extending portion 26 and the radially extending portion 27, and the bent portions 28′ are formed so as to have a radially outwardly convex circular arc shape that has a central angle that is 90 degrees.

Moreover, the stator 10A according to Embodiment 2 is configured in a similar or identical manner to the stator 10 according to Embodiment 1 above except that the connecting member 20A is used instead of the connecting member 20.

Stress-absorbing action by the connecting conductors 23′ will now be explained. Moreover, because the stress-absorbing action of the circumferentially extending portions 26 and the radially extending portions 27 is similar or identical to that of Embodiment 1 above, explanation thereof will be omitted here.

The bent portions 28′ are formed on the connecting conductors 23′ so as to have a radially outwardly convex circular arc shape. Thus, if the linking portions 24 displace radially inward relative to the coil terminals 13a due to thermal stresses or vibrational forces, the bent portions 28′ deform elastically so as to narrow an opening of the circular arc shape. If the linking portions 24 displace radially outward relative to the coil terminals 13a due to thermal stresses or vibrational forces, the bent portions 28′ deform elastically so as to widen the opening of the circular arc shape. If the linking portions 24 displace circumferentially toward the coil terminals 13a due to thermal stresses or vibrational forces, the bent portions 28′ deform elastically so as to narrow the opening of the circular arc shape. If the linking portions 24 displace circumferentially away from the coil terminals 13a due to thermal stresses or vibrational forces, the bent portions 28′ deform elastically so as to widen the opening of the circular arc shape.

Thus, displacement of the connecting conductors 23′ in the circumferential direction and the radial direction due to vibrational forces during vibration or thermal stresses is absorbed by the circumferentially extending portions 26, the radially extending portions 27, and the bent portions 28′ deforming elastically. Because increases in stresses that act on the connecting portions between the radially extending portions 27 and the coil terminals 13a are suppressed thereby, the state of the connections between the radially extending portions 27 and the coil terminals 13a will not deteriorate, nor will connection strength decrease, improving connection reliability of the connecting portions between the radially extending portions 27 and the coil terminals 13a.

Consequently, similar or identical effects to those in Embodiment 1 above can also be achieved in Embodiment 2.

Moreover, in Embodiment 2 above, the holder 21 is disposed at a first axial end of the stator core 11 radially outside a group of coils 13, but the holder 21 may be disposed at the first axial end of the stator core 11 radially inside the group of coils 13 so as to avoid interference with the rotor 5. In that case, the bent portions 28′ are formed so as to have radially inwardly convex circular arc shapes, i.e., circular arc shapes that bulge outward relative to the circumferentially extending portions 26 on an opposite side from the direction that the radially extending portions 27 extend from the bent portions 28′.

By making a bending radius of the circular arc-shaped bent portions 28′ greater than or equal to a sheet thickness of the connecting conductors 23′ decreases in stress-alleviating effects due to work hardening can be suppressed.

In Embodiment 2 above, the bent portions 28′ are formed so as to have a circular arc shape, but the bent portions 28′ are not limited to having a circular arc shape, provided that they have a curved surface shape, and they may have a U shape, for example.

Now, if the central angle of the circular arc shape of the bent portions 28′ is set to less than 180 degrees, the force that elastically deforms the bent portions 28′ so as to narrow the opening of the circular arc shape is increased. If the central angle of the circular arc shape of the bent portions 28′ if set to greater than 270 degrees, the force that elastically deforms the bent portions 28′ so as to widen the opening of the circular arc shape is increased. Thus, it is preferable for the central angle of the circular arc shape of the bent portions 28′ to be set to greater than or equal to 90 degrees and less than or equal to 270 degrees. Stresses in every direction in a plane that is perpendicular to the central axis of the rotary electric machine that accompany heat or vibrational forces, can thereby be absorbed by deformation of the connecting conductors 23′ enabling deterioration in connection state and reductions in joining strength between the connecting conductors 23′ and the coil terminals 13a to be suppressed.

Moreover, in each of the above embodiments, a stator winding is configured using concentrated windings, but the stator winding may be a distributed winding.

In each of the above embodiments, four grooves are formed concentrically on a holder, but the number of grooves is not limited to four.

In each of the above embodiments, a stator core includes twelve teeth, but the number of stator core teeth is set according to circumstances depending on specifications of a stator, namely, the number of slots.

In each of the above embodiments, phase coils are formed by connecting four coils in parallel, but configuration of the phase coils is not limited thereto, and phase coils may be configured by connecting four coils in series.

1. A rotary electric machine comprising:
a rotor;
a stator comprising:
a stator core in which a plurality of teeth are arranged circumferentially such that each protrudes radially inward from an inner circumferential surface of an annular back yoke portion; and
a plurality of coils that are mounted to said stator core, and that each have a pair of coil terminals that protrude outward from said stator core at a first axial end thereof,
said stator being disposed so as to be coaxial to said rotor so as to surround said rotor; and
a connecting member for delivering electric power to and from said plurality of coils,
wherein:
said connecting member comprises:
an electrically insulating holder that is formed so as to have a ring shape, that is disposed on a radially outer side of said plurality of coils at said first axial end of said stator, or that is disposed on a radially inner side of said plurality of coils at said first axial end of said stator, and in which a plurality of groove portions are formed concentrically so as to have openings at a first axial end;
a plurality of strip-shaped electrically conductive members that respectively extend circumferentially so as to be housed in each of said plurality of groove portions; and
a plurality of connecting conductors that are each formed so as to have a strip-shaped body that has a rectangular cross section, that extend outward from a side portion at a first axial end of each of said plurality of strip-shaped electrically conductive members, and that pass along said first axial end of said electrically insulating holder such that a longitudinal axis of said rectangular cross section is parallel to an axial direction, each of said connecting conductors being connected to a coil terminal that is intended for connection therewith among said coil terminals; and
said plurality of connecting conductors each comprise:
a circumferentially extending portion that extends circumferentially at said first axial end of said electrically insulating holder so as to be parallel to said strip-shaped electrically conductive member after extending outward from said side portion at said first axial end of said strip-shaped electrically conductive member; and
a radially extending portion that extends in a radial direction from an end portion at an opposite end of said circumferentially extending portion from said strip-shaped electrically conductive member by means of a bent portion, an end portion of said radially extending portion at an opposite end from said bent portion being connected to said coil terminal that is intended for connection therewith.

2. The rotary electric machine according to claim 1, wherein said bent portion is formed so as to have a curved surface shape that bulges outward relative to said circumferentially extending portion on an opposite side from a direction that said radially extending portion extends from said bent portion.

3. The rotary electric machine according to claim 2, wherein said bent portion has a circular arc shape.

4. The rotary electric machine according to claim 3, wherein a bending radius of said bent portion is greater than or equal to a thickness of said connecting conductors.

5. The rotary electric machine according to claim 3, wherein said bent portion is formed so as to have a circular arc shape that has a central angle that is greater than or equal to 180 degrees.

6. The rotary electric machine according to claim 1, wherein a length of said circumferentially extending portion of said plurality of connecting conductors becomes shorter if a length of said radially extending portion is increased.
